(19) United States
(12) Patent Application Publication
(10) Pub. No.: US 2018/0121056 A1
(43) Pub. Date: May 3, 2018

(54) ELECTRONIC APPARATUS, DISPLAY DEVICE, AND NON-TRANSITORY COMPUTER-READABLE RECORDING MEDIUM STORING OPERATION CONTROL PROGRAM

(71) Applicant: FUJITSU LIMITED, Kawasaki-shi (JP)

(72) Inventors: MIHO KYOYA, Kawasaki (JP); Kazuhiro FUJIWARA, Fuchu (JP); YOSUKE KIKUCHI, Kawasaki (JP); HIROKI MASUHARA, Kawasaki (JP)

(73) Assignee: FUJITSU LIMITED, Kawasaki-shi (JP)

(21) Appl. No.: 15/699,488

(22) Filed: Sep. 8, 2017

(30) Foreign Application Priority Data
Oct. 31, 2016 (JP) 2016-213771

(51) Int. Cl. G06F 3/0481; G06F 3/0488; G06F 3/041; G06F 1/16

(52) U.S. Cl. CPC G06F 3/04817; G06F 3/0488; G06F 2203/04102; G06F 1/1652; G06F 1/1616; G06F 3/0416

(57) ABSTRACT

An electronic apparatus includes: a display device including a first casing, a second casing openably and closably coupled to the first casing, and a flexible display and a touch panel provided astride over surfaces of the first casing and the second casing and configured to be bent according to an opened or closed state of the first casing and the second casing; and a processor configured to control the display device, wherein the processor: determines whether or not the first casing and the second casing are opened in a condition; and sets a region to be bent in a display region of the display device as a region of non-detection of a touch operation when determining that the first casing and the second casing are opened in the condition.

### CROSS-REFERENCE TO RELATED APPLICATION

This application is based upon and claims the benefit of priority of the prior Japanese Patent Application No. 2016-213771, filed on Oct. 31, 2016, the entire contents of which are incorporated herein by reference.

### FIELD

The embodiment discussed herein is related to an electronic apparatus, a display device, and a non-transitory computer-readable recording medium storing an operation control program.

### BACKGROUND

With the spread of mobile terminals such as smart phones, tablet terminals, and the like, the usage of the mobile terminals is a telephone function, and besides has been diversified, as in applications such as reading, moving image viewing, and the like. For such a reason, mobile terminals have also spread which have a liquid crystal screen increased in size, a dual display, or the like and may therefore display many pieces of information.

A related technology is disclosed in Japanese Laid-open Patent Publication No. 2007-71696 or International Publication Pamphlet No. WO 2014/125539.

### SUMMARY

According to an aspect of the embodiment, an electronic apparatus includes: a display device including a first casing, a second casing openably and closably coupled to the first casing, and a flexible display and a touch panel provided astride over surfaces of the first casing and the second casing and configured to be bent according to an opened or closed state of the first casing and the second casing; and a processor configured to control the display device, wherein the processor: determines whether or not the first casing and the second casing are opened in a condition; and sets a region to be bent in a display region of the display device as a region of non-detection of a touch operation when determining that the first casing and the second casing are opened in the condition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an electronic apparatus;

FIG. 2 is an example of a perspective view of a hinge of an electronic apparatus;

FIG. 3 is an example of a perspective view of a hinge of an electronic apparatus;

FIG. 4 is an example of an exploded view of a hinge;

FIG. 5 illustrates an example of hardware configuration of an electronic apparatus;

FIG. 6 illustrates an example of functional configuration of an electronic apparatus;

FIGS. 7A to 7C illustrate examples of a bending region;

FIG. 8 illustrates an example of state transition processing for a bending region;

FIG. 9 illustrates an example of processing at a time of occurrence of an event;

FIG. 10 illustrates an example of screen transitions at a time of occurrence of an event;

FIG. 11 illustrates an example of screen display based on touch operation at a time of occurrence of an event; and

FIG. 12 illustrates an example of relation between an angle and the number of icons to be arranged.

### DESCRIPTION OF EMBODIMENT

A mobile terminal including a large liquid crystal screen or a dual display, for example, has an increased area where a user may perform touch operation on a touch panel. Thus, good user operability may not be provided.

For example, when the screen becomes larger, an icon or the like displayed at an edge of the screen may be difficult to operate with one hand while holding the mobile terminal with the same hand, and an annoying operation of switching to holding with both hands or the like may occur. When the mobile terminal is held as in the case of a book to perform reading, for example, a finger may touch the screen, and cause an unintended operation.

An electronic apparatus that improves user operability or the like, for example, may be provided.

An embodiment to be illustrated in the following may be combined with each other as appropriate within a scope in which no inconsistency arises.

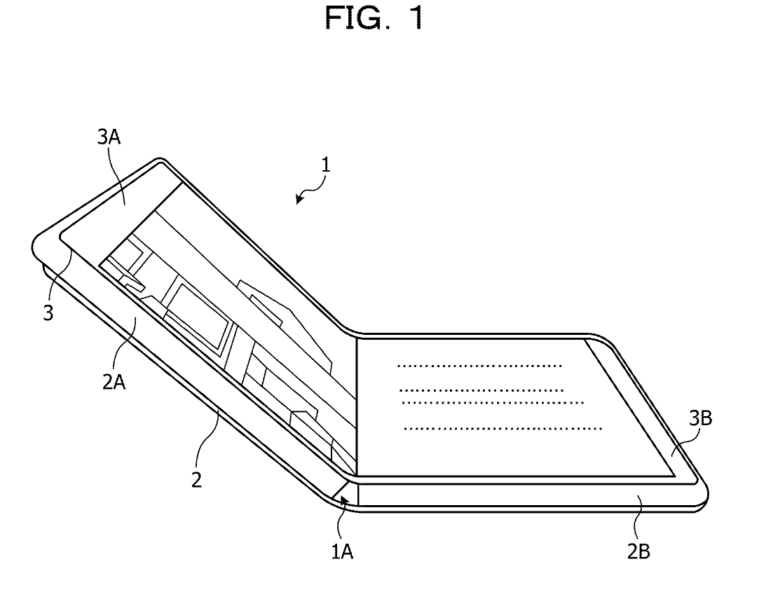

FIG. 1 illustrates an example of an electronic apparatus. An electronic apparatus 1 may be a smart phone, a tablet terminal, or the like, or may be a mobile terminal having a telephone function, an email function, a function of executing various kinds of applications, and the like.

The electronic apparatus 1 illustrated in FIG. 1 may be an electronic apparatus in which a screen displaying information such as icons and the like and receiving touch operation of a user is configured to be bent. For example, the electronic apparatus 1 includes a display device 2 including a first casing 2A, a second casing 2B openably and closably coupled to the first casing 2A, and a flexible display 3 disposed astride over respective principal surfaces of the first casing 2A and the second casing 2B and bent according to the opened/closed state of the first casing 2A and the second casing 2B.

The flexible display 3 includes a touch panel of a capacitive type, an electromagnetic induction type, or the like, and receives various kinds of user operations via the touch panel so that an application and the like are executed. The flexible display 3 is a display including a screen region 3A and a screen region 3B, and has a constitution bent by a hinge 1A. On the flexible display 3, various kinds of information are displayed with the screen region 3A and the screen region 3B as one region, or the region is divided into the screen region 3A and the screen region 3B and various kinds of information are displayed in a divided manner in the respective regions.

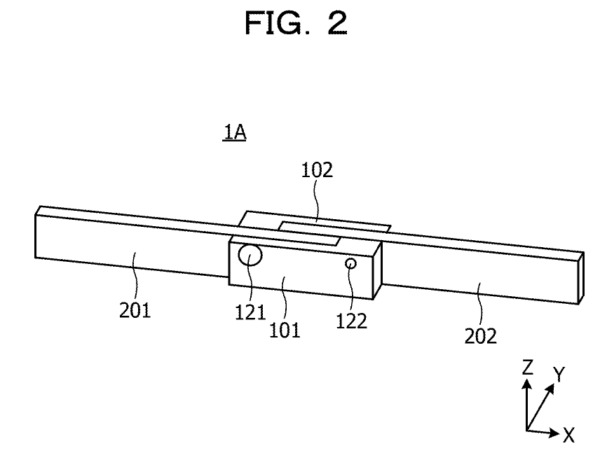

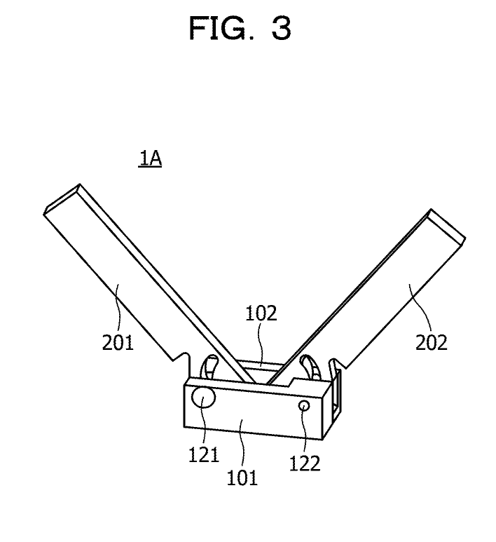

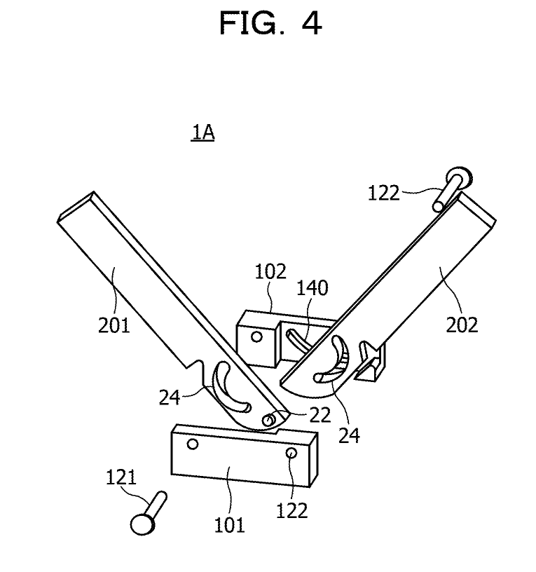

The first casing 2A and the second casing 2B are openably and closably coupled to each other by the hinge 1A. FIG. 2 and FIG. 3 are examples of perspective views illustrating a hinge. FIG. 2 illustrates the hinge 1A in a closed state (degree of opening is zero). FIG. 3 illustrates the hinge 1A in an opened state. FIG. 4 is an example of an exploded view of a hinge.

The hinge 1A includes combinations of two sets of first members 101 and 102 and second members 201 and 202. The provision of the combinations of the plurality of sets of members increases an amount of relative displacement of the hinge 1A. The hinge 1A includes the first members 101 and 102 and the second members 201 and 202. The first member 101 and the second member 201 form a set. The first member 102 and the second member 202 form another set.

The first members 101 and 102 each include first protrusions 121 and 122 projecting in a Y-axis direction and a first groove 140 in the shape of an arc. The first groove 140 of the first member 101 is formed on a side facing the second member 202, and is therefore not visible in FIGS. 2 to 4. The first members 101 and 102 are fixed to each other.

The second members 201 and 202 each include a second protrusion 22 projecting in the Y-axis direction and a second groove 24 in the shape of an arc. The second protrusion 22 of the second member 202 is formed on a side facing the first member 102, and is therefore not visible in FIGS. 2 to 4. The second members 201 and 202 are displaced independently of each other. The second members 201 and 202 abut against each other in the Y-axis direction in FIGS. 2 and 3, but do not mutually restrict degrees of freedom of movement thereof in an XZ plane. For example, the second members 201 and 202 are in slidable relation to each other in the XZ plane.

The first protrusion 121 of the first member 101 is fitted into the second groove 24 of the second member 201. The second protrusion 22 of the second member 201 is fitted into the first groove 140 of the first member 101. The first protrusion 122 of the first member 102 is fitted into the second groove 24 of the second member 202. The second protrusion 22 of the second member 202 is fitted into the first groove 140 of the first member 102.

The second member 201 is displaced relative to the first member 101. The second member 201 is displaced relative to the first member 101 in a mode in which the second protrusion 22 fitted in the first groove 140 of the first member 101 moves along the first groove 140, and the first protrusion 121 of the first member 101, the first protrusion 121 being fitted in the second groove 24, moves along the second groove 24. At this time, the second member 201 is, for example, displaced relative to the first member 101 in a mode of describing an involute curve. An opening direction of the second member 201 with respect to the first member 101 corresponds to a clockwise direction as viewed in a positive direction of the Y-axis, as illustrated in FIG. 3.

The second member 202 is displaced relative to the first member 102. The second member 202 is displaced relative to the first member 102 in a mode in which the second protrusion 22 fitted in the first groove 140 of the first member 102 moves along the first groove 140, and the first protrusion 122 of the first member 102, the first protrusion 122 being fitted in the second groove 24, moves along the second groove 24. At this time, the second member 202 is, for example, displaced relative to the first member 102 in a mode of describing an involute curve. An opening direction of the second member 202 with respect to the first member 102 is opposite to the opening direction of the second member 201 with respect to the first member 101, and corresponds to a counterclockwise direction as viewed in the positive direction of the Y-axis, as illustrated in FIG. 3. Therefore, a possible range of an angle formed between the second member 201 and the second member 202, for example, an angle α to be described later may be increased.

The set of the first member 101 and the second member 201 and the set of the first member 102 and the second member 202 may be arranged so as to be adjacent to each other in the Y-axis direction as described above, or may be arranged so as to be separated from each other in the Y-axis direction.

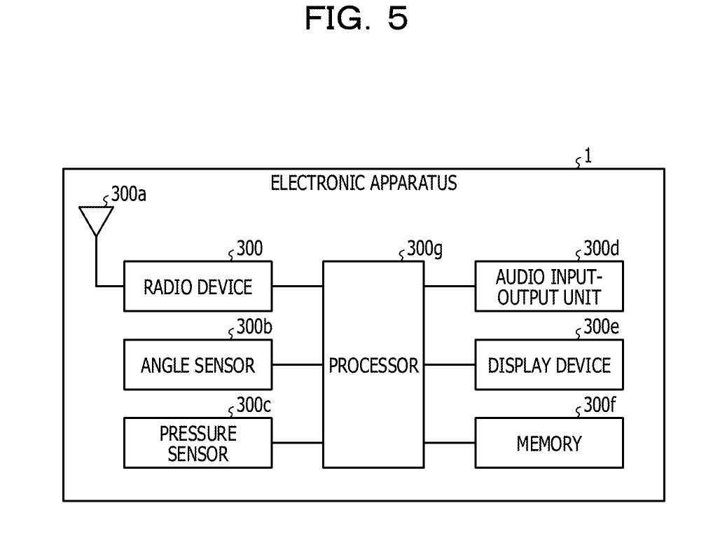

FIG. 5 illustrates an example of hardware configuration of an electronic apparatus. The electronic apparatus depicted in FIG. 5 may be the electronic apparatus 1 depicted in FIG. 1. As illustrated in FIG. 5, the electronic apparatus 1 includes a radio device 300, an angle sensor 300b, a pressure sensor 300c, an audio input-output unit 300d, a display device 300e, a memory 300f, and a processor 300g. The hardware illustrated in FIG. 5 is an example. The electronic apparatus 1 may include other hardware such as a hard disk, an acceleration sensor, and/or the like.

The radio device 300 performs radio communication with a base station or another information processing device via an antenna 300a. The angle sensor 300b is a sensor detecting a bending angle of the flexible display 3, for example, an opening/closing angle between the first casing 2A and the second casing 2B or an opening/closing angle of the hinge 1A. The pressure sensor 300c is a sensor detecting a pressure applied to the touch panel. The pressure sensor 300c detects a pressure at a time of touch operation of a user, a pressure applied when the user holds the electronic apparatus 1, or the like.

The audio input-output unit 300d outputs sound from a speaker, and performs various kinds of processing on sound collected by a microphone. The display device 300e may be an example of a device displaying various kinds of information. The display device 300e may, for example, be a flexible display on which a touch panel is superposed.

The memory 300f may be an example of a storage device storing programs and data. Cited as an example of the memory 300f is a random access memory (RAM) such as a synchronous dynamic random access memory (SDRAM) or the like, a read only memory (ROM), a flash memory, or the like.

The processor 300g is a processing unit that controls processing of the electronic apparatus 1 as a whole. The processor 300g, for example, reads a program from the hard disk or the like, expands the program in the memory 300f, and executes a process that performs each piece of processing. Cited as an example of the processor 300g is a central processing unit (CPU), a digital signal processor (DSP), a field programmable gate array (FPGA), a programmable logic device (PLD), or the like. The program may be distributed via a network such as the Internet or the like. The program may be recorded on a computer readable recording medium such as a hard disk, a flexible disk (FD), a compact disc (CD)-ROM, a magneto-optical disk (MO), a digital versatile disc (DVD), or the like, and may be executed by being read from the recording medium by a computer.

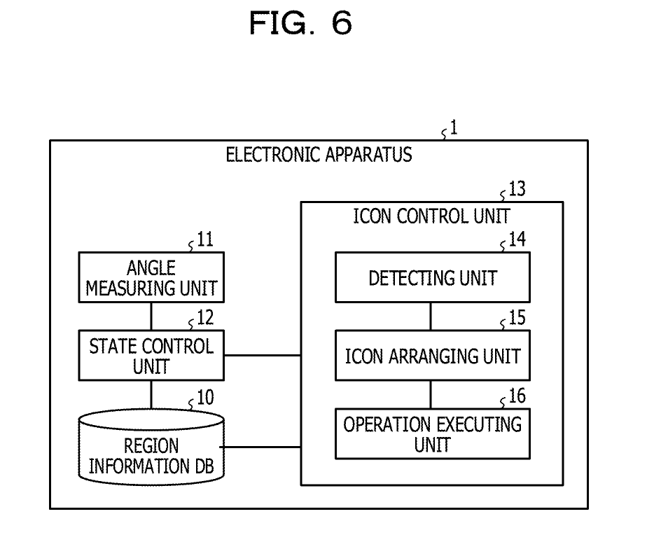

FIG. 6 illustrates an example of functional configuration of an electronic apparatus. As illustrated in FIG. 6, the electronic apparatus 1 includes a region information database (DB) 10, an angle measuring unit 11, a state control unit 12, and an icon control unit 13. The region information DB 10 is stored in the storage device such as the memory or the like. The angle measuring unit 11, the state control unit 12, and the icon control unit 13 may be an example of an electronic circuit included in the processor or the like, or an example of a process executed by the processor.

The region information DB 10 is a database storing region information about a bending region, for example, a region to be bent, and region information about other flat regions. For example, the region information DB 10 stores, for each piece of region information, coordinates of four points, for example, “X-axis coordinates and Y-axis coordinates,” which identify the region.

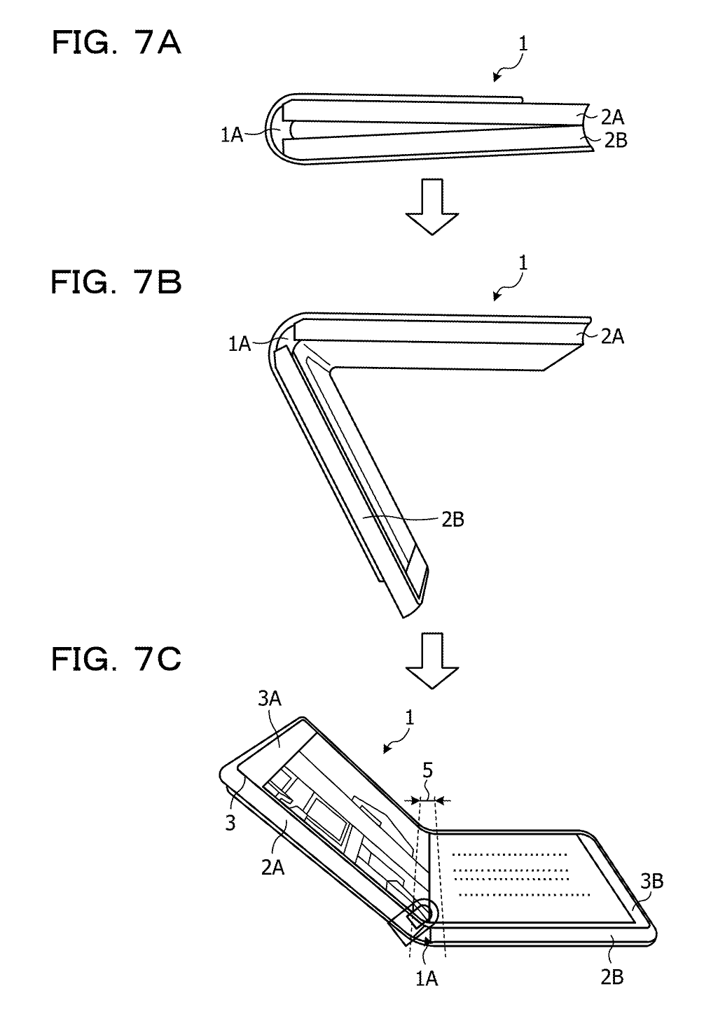

FIGS. 7A to 7C illustrate examples of a bending region. FIGS. 7A to 7C illustrate an example of making the electronic apparatus 1 make a transition from a closed state to an opened state. As illustrated in FIG. 7A, a bending region 5 refers to a region where the screen region 3A and the screen region 3B of the flexible display 3 are most distant from each other without being in contact with each other when the electronic apparatus 1 is in the closed state.

As illustrated in FIG. 7C, for example, the bending region 5 is a region that a thumb or the like of a user is in contact with when the user holds the electronic apparatus 1 to use the electronic apparatus 1 for an application as in the case of a paperback edition of a book or the like. This region may be changed arbitrarily according to the size of the flexible display 3 or the like.

(Closed State)

As illustrated in FIG. 7A, when the first casing 2A and the second casing 2B are in the closed state, the principal surfaces of the first casing 2A and the second casing 2B face each other. At this time, the flexible display 3 is in a state of being folded double. When the first casing 2A and the second casing 2B are in the closed state, opening/closing end portions of the first casing 2A and the second casing 2B abut against each other. A gap occurs between the first casing 2A and the second casing 2B on a side where the hinge 1A coupling the first casing 2A and the second casing 2B to each other is disposed. This gap may suppress crushing of the flexible display 3 by the first casing 2A and the second casing 2B. Therefore, the flexible display 3 is in a state of being curved without being bent at an acute angle. A stress locally concentrated on the flexible display 3 may consequently be suppressed. At this time, the bending region 5 may correspond to a region on the flexible display 3 which region corresponds to a position where the hinge 1A is disposed or a curved region of the flexible display 3.

(Transition from Closed State to Opened State)

As illustrated in FIGS. 7A to 7C, when the first casing 2A and the second casing 2B make a transition from the closed state to the opened state, the flexible display 3 in the folded state is gradually unfolded with an opening operation of the first casing 2A and the second casing 2B. At this time, the curved surface of the bending region 5 is deformed as the transition is made from the closed state to the opened state. For example, the bending region 5 is deformed so as to increase the radius of curvature of the curved surface as the transition is made from the closed state to the opened state.

(Transition from Opened State to Closed State)

When the first casing 2A and the second casing 2B make a transition from the opened state to the closed state contrary to the order illustrated in FIGS. 7A to 7C, the flexible display 3 in the unfolded state is gradually folded with a closing operation of the first casing 2A and the second casing 2B. At this time, the curved surface of the bending region 5 is deformed as the transition is made from the opened state to the closed state. For example, the bending region 5 is deformed so as to decrease the radius of curvature of the curved surface as the transition is made from the opened state to the closed state.

(Opened State)

When the first casing 2A and the second casing 2B are in the opened state, the principal surfaces of the first casing 2A and the second casing 2B face in a same front direction. At this time, the first casing 2A and the second casing 2B are arranged side by side in a planar shape. The principal surfaces of the first casing 2A and the second casing 2B are covered by the flexible display 3. Hence, the flexible display 3 is unfolded in a planar shape, and the bending region 5 is, for example, in a planar shape.

The angle measuring unit 11 illustrated in FIG. 6 may be a processing unit that measures the opening/closing angle of the electronic apparatus 1, for example, the opening/closing angle between the first casing 2A and the second casing 2B. For example, the angle measuring unit 11 obtains the angle measured by the angle sensor 300b as needed, and outputs the angle to the state control unit 12.

The state control unit 12 is a processing unit that controls enabling or disabling of touch operation on the bending region 5 according to the opening/closing angle of the electronic apparatus 1. For example, when the angle input from the angle measuring unit 11 is 180 degrees, the state control unit 12 sets touch operation on the bending region 5 in an enabled state. When the angle input from the angle measuring unit 11 is not 180 degrees, the state control unit 12 sets touch operation on the bending region 5 in a disabled state. The state control unit 12 outputs information about the setting made to the icon control unit 13. The 180 degrees may be used as an example of a threshold value as described above, or the angle may be set and changed arbitrarily.

The state control unit 12 changes a region in which touch operation is set in the disabled state in the bending region 5 according to the angle input from the angle measuring unit 11. For example, the state control unit 12 changes the region in which touch operation is set in the disabled state in the bending region 5 so as to narrow the region as a transition is made from the opened state to the closed state. The state control unit 12 changes the region in which touch operation is set in the disabled state in the bending region 5 so as to widen the region as a transition is made from the closed state to the opened state.

The icon control unit 13 includes a detecting unit 14, an icon arranging unit 15, and an operation executing unit 16. The icon control unit 13 may be a processing unit that performs various kinds of processing when events such as email reception, an incoming call, and the like occur in a case where touch operation on the bending region 5 is in the disabled state. When touch operation on the bending region 5 is in the enabled state, touch operation may be substantially the same as or similar to touch operation using an ordinary touch panel.

The detecting unit 14 is a processing unit that detects the occurrence of an event. For example, the detecting unit 14 monitors various applications, detects event execution of an application or the like, and notifies the event execution of the application or the like to the icon arranging unit 15. For example, when the detecting unit 14 detects an incoming call, email reception, a game event, social networking service (SNS) notification reception, or the like, the detecting unit 14 notifies information identifying a detected application or the like to the icon arranging unit 15.

The icon arranging unit 15 is a processing unit that disposes an icon for starting the application notified from the detecting unit 14 in the bending region 5. For example, when SNS notification reception or the like is notified from the detecting unit 14 to the icon arranging unit 15, the icon arranging unit 15 displays an SNS icon capable of touch operation in the bending region 5 while holding touch operation on the bending region 5 in the disabled state. A position at which the icon is displayed may be set arbitrarily. For example, the position at which the icon is displayed may be in a direction in which a hand (finger) of the user is in contact with the touch panel (flexible display 3) (downward direction of the electronic apparatus 1) with respect to the center of the bending region 5.

The operation executing unit 16 is a processing unit that detects a touch operation on the icon displayed by the icon arranging unit 15, and executes a corresponding application. For example, when the operation executing unit 16 detects a touch operation on the icon displayed in the bending region 5 in which touch operation is suppressed, the operation executing unit 16 displays an execution screen of the application corresponding to the icon in the screen region 3A or the screen region 3B of the flexible display 3 including the touch panel. The operation executing unit 16 may, for example, display the execution screen of the application in a state of being superimposed on a screen already displayed.

The operation executing unit 16 may determine in advance whether to display the execution screen of the application in the screen region 3A or the screen region 3B, or may dynamically determine whether to display the execution screen of the application in the screen region 3A or the screen region 3B.

For example, when the user holds the electronic apparatus 1 with one hand, the operation executing unit 16 may determine whether the holding hand is a right hand or a left hand, and may dynamically display the execution screen of the application in the screen region on an opposite side from the holding hand. For example, the operation executing unit 16 displays the execution screen of the application in the screen region 3A, which is the left screen of the flexible display 3, when the holding hand is the right hand, or displays the execution screen of the application in the screen region 3B, which is the right screen of the flexible display 3, when the holding hand is the left hand.

The operation executing unit 16 may, for example, identify the hand holding the electronic apparatus 1 based on a region in which the touch panel and the hand are in contact with each other. For example, the operation executing unit 16 identifies the region in which the touch panel and the hand are in contact with each other, and determines that the electronic apparatus 1 is held by the left hand when a contact region of the screen region 3A is larger than a contact region of the screen region 3B or determines that the electronic apparatus 1 is held by the right hand when the contact region of the screen region 3B is larger. The holding hand may be set by the user in advance.

The operation executing unit 16 may identify the hand holding the electronic apparatus 1 based on the screen region to which belongs a region with a highest pressure in the region in which the touch panel and the hand are in contact with each other. For example, the operation executing unit 16 may determine that the electronic apparatus 1 is held by the left hand when the region with the highest pressure belongs to the screen region 3A, or may determine that the electronic apparatus 1 is held by the right hand when the region with the highest pressure belongs to the screen region 3B. The pressure may, for example, be obtained from the pressure sensor 300c or the like.

The operation executing unit 16 may identify the hand holding the electronic apparatus 1 from a direction in which a contact area of the hand in contact with the touch panel extends. For example, when a longitudinal direction of the electronic apparatus 1 is an X-axis, a lateral direction of the electronic apparatus 1 is a Y-axis, and a boundary between the screen region 3A and the screen region 3B is at (X, Y)=(0, 0), the operation executing unit 16 may identify the holding hand based on a vector direction in which the hand is in contact with the touch panel. For example, with the position of (X, Y)=(0, 0) as an origin, the operation executing unit 16 may determine that the electronic apparatus 1 is held by the left hand in a case of a vector in a positive direction of the X-axis (direction of the screen region 3B) and a positive direction of the Y-axis (opposite direction from the hand). Similarly, the operation executing unit 16 may determine that the electronic apparatus 1 is held by the right hand in a case of a vector in a negative direction of the X-axis (direction of the screen region 3A) and the positive direction of the Y-axis (opposite direction from the hand). In the case of FIG. 7C, for example, it may be determined that the electronic apparatus 1 is held by the left hand because an extension of a contact direction (vector direction) of a finger intersects the screen region 3B.

When the icon is slid by a flick operation, for example, the operation executing unit 16 displays the execution screen of the application in a screen region in the flick direction, for example, a screen region as a slide destination. For example, the operation executing unit 16 displays the execution screen of the application in the screen region 3A when the icon is slid to the screen region 3A, or displays the execution screen of the application in the screen region 3B when the icon is slid to the screen region 3B.

The operation executing unit 16, for example, ends the display of the icon when not detecting touch operation on the icon within a given time (for example, one minute) of the display of the icon. The operation executing unit 16 ends the display of the icon when the flick operation slides the icon within the bending region 5.

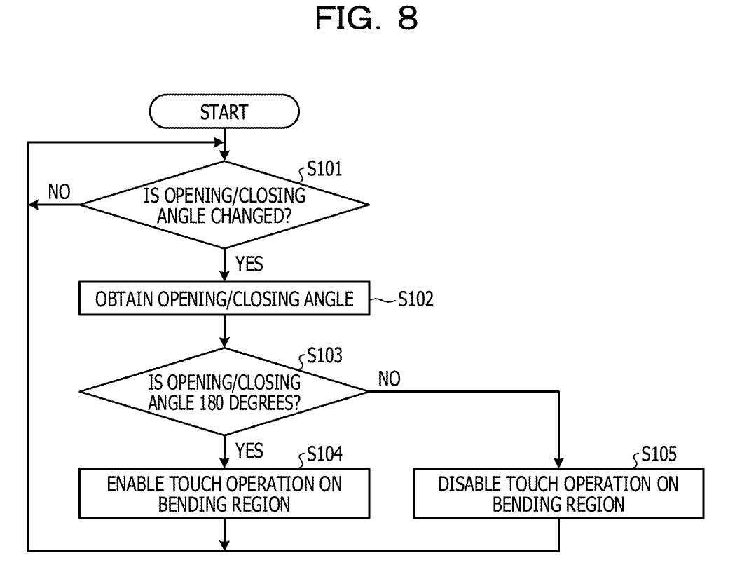

FIG. 8 illustrates an example of state transition processing for a bending region. As illustrated in FIG. 8, when the opening/closing angle is changed (S101: Yes), the angle measuring unit 11 obtains the opening/closing angle from the angle sensor 300b (S102). The angle measuring unit 11 may obtain the opening/closing angle measured from the angle sensor 300b as needed.

When the obtained opening/closing angle is 180 degrees (S103: Yes), the state control unit 12 sets touch operation on the bending region 5 enabled (in the enabled state) (S104). When the obtained opening/closing angle is not 180 degrees (S103: No), the state control unit 12 sets touch operation on the bending region 5 disabled (in the disabled state) (S105).

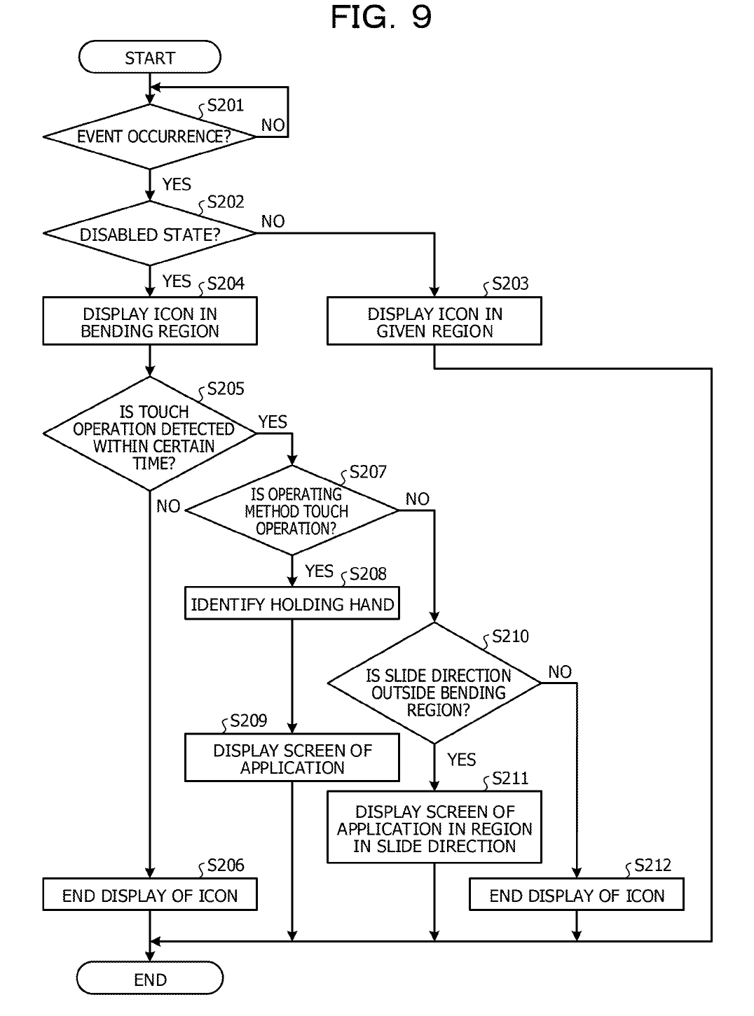

FIG. 9 illustrates an example of processing at a time of occurrence of an event. As illustrated in FIG. 9, when the detecting unit 14 detects the occurrence of an event (S201: Yes), the icon arranging unit 15 determines whether or not the bending region 5 is in the disabled state (S202). When it is determined that the bending region 5 is not in the disabled state but is in the enabled state (S202: No), an icon is displayed in a given region of the touch panel (S203).

When the icon arranging unit 15 determines that the bending region 5 is in the disabled state (S202: Yes), the icon arranging unit 15 sets a region capable of touch operation in the bending region 5, and displays the icon of an application for which the event has occurred in the set region (S204).

When the operation executing unit 16 does not detect any operation such as a touch operation or the like on the displayed icon within a certain time (S205: No), the operation executing unit 16 ends the display of the icon (S206).

When the operation executing unit 16 detects an operation such as a touch operation or the like on the displayed icon within the certain time (S205: Yes), the operation executing unit 16 enables touch operation on the bending region 5 for a certain time, and determines whether or not an operating method is a touch operation (S207).

When the operating method is a touch operation (S207: Yes), the operation executing unit 16 identifies whether a holding hand is a right hand or a left hand (S208), and displays an execution screen of the corresponding application in a screen region on an opposite side from the holding hand (S209).

When the operating method is not a touch operation but is a flick operation (S207: No), the operation executing unit 16 determines whether or not a direction in which the icon is slid by the flick operation is outside the bending region 5 (S210).

When the operation executing unit 16 determines whether or not the direction in which the icon is slid is outside the bending region 5, and the icon is slid to the outside of the bending region 5 (S210: Yes), the operation executing unit 16 displays the execution screen of the corresponding application in a screen region in the slide direction (S211). When the direction in which the icon is slid is within the bending region 5 (S210: No), the operation executing unit 16 ends the display of the icon (S212).

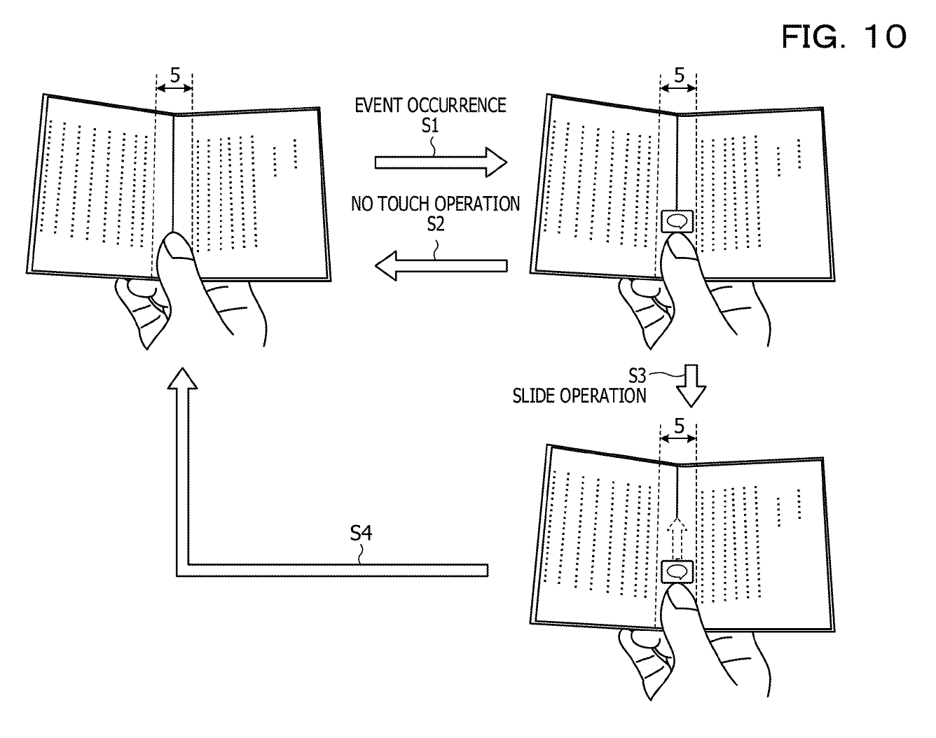

FIG. 10 illustrates an example of screen transitions at a time of occurrence of an event. As illustrated in FIG. 10, when the electronic apparatus 1 detects the occurrence of an event for an application in a state of executing a reading application or the like and displaying a novel or the like, the electronic apparatus 1 displays the icon of the application in the bending region 5 (S1).

When the electronic apparatus 1 thereafter does not detect any touch operation on the displayed icon, the electronic apparatus 1 ends the display of the icon (S2). The electronic apparatus 1 ends the display of the icon (S4) also when the displayed icon is slid within the bending region 5 by a flick operation (S3). While FIG. 10 represents a case where the icon is slid in an opposite direction from a hand as an example of a slide direction, similar processing may also be performed in a case where the icon is slid in the same direction as the hand.

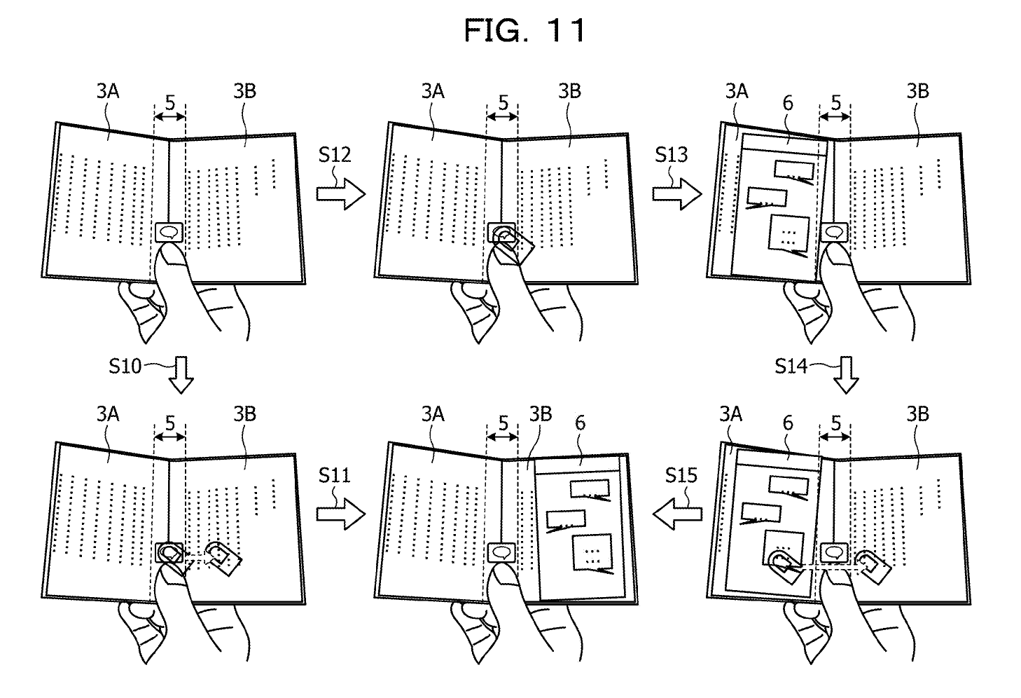

FIG. 11 illustrates an example of screen display based on touch operation at a time of occurrence of an event. As illustrated in FIG. 11, the electronic apparatus 1 displays an icon in the bending region 5 in a state of executing a reading application or the like and displaying a novel or the like.

When the icon is slid to the screen region 3B by a flick operation in this state (S10), the electronic apparatus 1 displays an execution screen 6 of an application in the screen region 3B (S11).

When the electronic apparatus 1 detects a touch operation on the icon displayed in the bending region 5 (S12), because a hand holding the electronic apparatus 1 is a right hand, the electronic apparatus 1 displays the execution screen 6 of the application in the screen region 3A on an opposite side from the right hand (S13). When the execution screen 6 of the application, the execution screen 6 being displayed in the screen region 3A, is slid to the screen region 3B by a flick operation in this state (S14), the electronic apparatus 1 moves the execution screen 6 of the application from the screen region 3A to the screen region 3B by the operation executing unit 16 (S15). For example, the electronic apparatus 1 displays the execution screen 6 of the application in the screen region 3B rather than in the screen region 3A.

As described above, the electronic apparatus 1 disables touch operation on a region where a finger as an example of an indicator touches the screen until an event occurs. Therefore, the occurrence of unintended operation due to the touching of the screen by the finger is reduced. User operability may consequently be improved. Even in the case where the touch panel having the bending region 5 is disposed in the electronic apparatus 1, a state transition of touch operation on the bending region 5 that a hand of the user touches is effected based on the occurrence of an event. User operability may therefore be improved.

The electronic apparatus 1 may receive a flick operation or the like also on an icon displayed in the bending region 5 as in the case of an ordinary icon. The electronic apparatus 1 receives a flick operation or the like also on an execution screen of an application. Hence, the user may perform screen display and screen switching by operations not different from those of an ordinary icon.

As described above, an icon or the like may be slid by a flick operation. Similar processing may be performed also when a mere flick operation in a sliding direction is detected without the icon or the like being actually slid.

The electronic apparatus 1 may, for example, arrange icons capable of touch operation in the bending region 5 in advance, or may arrange frequently used icons or the like in a state of being capable of touch operation in the bending region 5. At this time, the electronic apparatus 1 may dynamically change the number of icons to be arranged according to the opening/closing angle of the electronic apparatus 1. For example, the electronic apparatus 1 may retain a DB associating the angle with the arrangement number of icons, and change the arrangement number based on the DB.

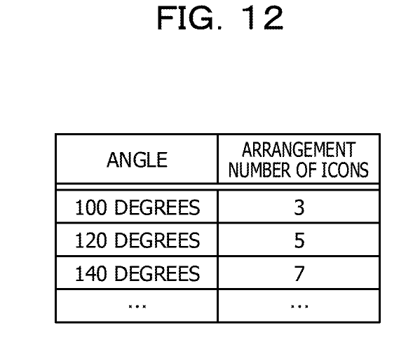

FIG. 12 illustrates an example of relation between an angle and the number of icons to be arranged. As illustrated in FIG. 12, the electronic apparatus 1 retains a DB associating the angle representing the opening/closing angle with the arrangement number of icons, the arrangement number of icons representing the number of icons to be arranged. In FIG. 12, the electronic apparatus 1 arranges three icons when the opening/closing angle is 100 degrees, and arranges seven icons when the opening/closing angle is 140 degrees. The electronic apparatus 1 may give priority to frequently used icons as an example of selecting icons to be displayed. The user may set the icons to be displayed in advance.

The electronic apparatus 1 may, for example, display icons in a state of not receiving touch operation when the opening/closing angle at a time of occurrence of an event is less than a threshold value, for example, 120 degrees. The icons may be changed to a state of being able to receive touch operation when the opening/closing angle thereafter exceeds the threshold value. The threshold value and the given time described above or the like may be set and changed arbitrarily.

The whole or a part of the above-described processing performed automatically may be performed manually. For example, the whole or a part of the above-described processing performed manually may be performed automatically. For example, a part of the above-described processing may be performed by a publicly known method. The processing procedures, the control procedures, the specific names, or the information including various data and parameters described above may be changed arbitrarily unless otherwise specified.

The constituent elements of each device described above may be functionally conceptual, and may not physically have the illustrated configuration. For example, the whole or a part of each device may be distributed or integrated functionally or physically in arbitrary units according to various loads, usage conditions, and the like. For example, the whole or an arbitrary part of each processing function performed in each device may be implemented by a CPU and a program analyzed and executed in the CPU, or may be implemented as hardware based on wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An electronic apparatus comprising:
a display device including a first casing, a second casing openably and closably coupled to the first casing, and a flexible display and a touch panel provided astride over surfaces of the first casing and the second casing and configured to be bent according to an opened or closed state of the first casing and the second casing; and
a processor configured to control the display device, wherein
the processor:
determines whether or not the first casing and the second casing are opened in a condition; and
sets a region to be bent in a display region of the display device as a region of non-detection of a touch operation when determining that the first casing and the second casing are opened in the condition.

2. The electronic apparatus according to claim 1, wherein the processor:
detects occurrence of an event; and
disposes an icon that receives the touch operation in the region to be bent when detecting the occurrence of the event.

3. The electronic apparatus according to claim 1, wherein the processor:
disposes an icon in the region to be bent;
identifies a planar region to which an indicator touching the region to be bent moves when detecting the touch operation on the icon; and
displays an execution screen of an application in the planar region.

4. The electronic apparatus according to claim 1, wherein the processor:
detects an angle at which the first casing and the second casing are opened; and
changes a number of icons that are arranged in the region to be bent and receive the touch operation according to the angle.

5. The electronic apparatus according to claim 1, wherein the processor:
identifies a holding hand of a user;
disposes an icon in the region to be bent; and
displays an execution screen of an application corresponding to the icon in a part based on the identified hand when detecting the touch operation on the icon.

6. The electronic apparatus according to claim 5, wherein the processor displays the execution screen of the application in a planar region on an opposite side from the holding hand of the user.

7. The electronic apparatus according to claim 1, wherein a radius of curvature of the region to be bent changes as the first casing and the second casing are opened or closed.

8. A display device comprising:
a flexible display and a touch panel that are provided astride over surfaces of a first casing and a second casing openably and closably coupled to the first casing, and are bent according to an opened or closed state of the first casing and the second casing; and
a display region including a region to be bent which is set as a region of non-detection of a touch operation when it is determined that the first casing and the second casing are opened in a condition.

9. The display device according to claim 8, wherein an icon that receives the touch operation is disposed in the region to be bent when an occurrence of an event is detected.

10. The display device according to claim 8, wherein a planar region to which an indicator touching the region to be bent moves is identified when the touch operation on an icon disposed in the region to be bent is detected and an execution screen of an application is displayed in the planar region.

11. The display device according to claim 8, wherein a number of icons that are arranged in the region to be bent and receive the touch operation is changed according to an angle at which the first casing and the second casing are opened.

12. The display device according to claim 8, wherein an execution screen of an application corresponding to an icon disposed in the region to be bent is displayed in a part based on a holding hand of a user when the touch operation on the icon is detected.

13. The display device according to claim 12, wherein the execution screen of the application is displayed in a planar region on an opposite side from the holding hand of the user.

14. The display device according to claim 8, wherein a radius of curvature of the region to be bent is changed as the first casing and the second casing are opened or closed.

15. A non-transitory computer-readable recording medium storing an operation control program making a computer perform processing, the processing comprising:
determining whether or not a first casing and a second casing openably and closably coupled to the first casing of a display device are opened in a condition, the display device including a flexible display and a touch panel which is astride over surfaces of the first casing and the second and is bent according to an opened or closed state of the first casing and the second casing; and
setting a region to be bent in a display region of the display device as a region of non-detection of a touch operation when determining that the first casing and the second casing are opened in the condition.

16. The non-transitory computer-readable recording medium according to claim 15, further comprising:
detecting occurrence of an event; and
disposing an icon that receives the touch operation in the region to be bent when detecting the occurrence of the event.

17. The non-transitory computer-readable recording medium according to claim 15, further comprising:
disposing an icon in the region to be bent;
identifying a planar region to which an indicator touching the region to be bent moves when detecting the touch operation on the icon; and
displaying an execution screen of an application in the planar region.

18. The non-transitory computer-readable recording medium according to claim 15, further comprising:
detecting an angle at which the first casing and the second casing are opened; and
changing a number of icons that are arranged in the region to be bent and receive the touch operation according to the angle.

19. The non-transitory computer-readable recording medium according to claim 15, further comprising:
identifying a holding hand of a user;
disposing an icon in the region to be bent; and
displaying an execution screen of an application corresponding to the icon in a part based on the identified hand when detecting the touch operation on the icon.

20. The non-transitory computer-readable recording medium according to claim 15, wherein a radius of curvature of the region to be bent changes as the first casing and the second casing are opened or closed.
